(19) United States
(12) Patent Application Publication
(10) Pub. No.: US 2007/0199777 A1
(43) Pub. Date: Aug. 30, 2007

(54) Drum brake

(75) Inventor: Hironori Akada, Tokyo (JP)

Correspondence Address: DRINKER BIDDLE & REATH (DC), 1500 K STREET, N.W., SUITE 1100, WASHINGTON, DC, 20005-1209, US

(73) Assignee: AKEBONO BRAKE INDUSTRY CO., LTD.

(21) Appl. No.: 11/710,441

(22) Filed: Feb. 26, 2007

(30) Foreign Application Priority Data
Feb. 27, 2006 (JP) P. 2006-049609

(51) Int. Cl. B60T 8/18

(52) U.S. Cl. 188/195; 188/74

(57) ABSTRACT

Faces of a rim portion 20b of a brake shoe 20 of a drum brake brought into contact with a backing plate 18 on a side of a wheel cylinder and on a side of an anchor are brought into contact with and supported by first ledge portions “b”, “c” formed at an upper face of the backing plate, and a face of the rim portion 20b of the brake shoe 20 formed substantially at a center position thereof and brought into contact with the backing plate 18 is brought into contact with and supported by a second ledge portion “a” formed at a lower face of a cut-to-rise portion 18a of the backing plate 18.

This application claims foreign priority from Japanese Patent Application No. 2006-049609, filed on Feb. 27, 2006, the entire contents of which are hereby incorporated by reference.

### BACKGROUND OF THE INVENTION

1. Field of the Invention

The present invention relates to a shoe hold-down mechanism in a drum brake in which a brake shoe is slidably supported on a backing plate, and a spring force of a return spring is operated to the brake shoe at a position of being offset from a center in a direction of a width of a rim of the brake shoe in a direction of being remote from the backing plate.

2. Related Art

According to a drum brake in a back ground art, there is used a shoe hold-down mechanism comprising a coil spring and a shoe hold-down pin such that a brake shoe is slidably supported stably on a backing plate even when the brake shoe is jumped from the backing plate by vibration or the like, or the brake shoe receives a rotational moment of being floated up from the backing plate by an influence of a return spring (refer to, for example, FIG. 2 of JP-U-62-204045).

FIG.6 shows a partial sectional view of such a shoe hold-down mechanism of a background art comprising a coil spring and a shoe hold-down pin. As shown in FIG. 6, according to the shoe hold-down mechanism 1, abase portion 4a of a shoe hold-down pin 4 is locked by a locking hole 3 formed at a backing plate 2 by way of an elastic plate 5, and a side of a head portion of the shoe hold-down pin 4 extended to penetrate an elongated hole 6a of a shoe web 6 is arranged with a coil spring 8 pinched between washers 7, 7. The brake shoe is always pressed to a side of the backing plate 2 by a spring force of the coil spring 8, and therefore, the brake shoe is supported in a stable state without floating up from the backing plate even when the brake shoe is operated with an external force, or receives a rotational moment by a return spring.

According to the shoe hold-down mechanism in a drum brake of the background art described in JP-U-62-204045, the shoe hold-down pin 4, the coil spring 8, two of the washers 7, 7 and the elastic plate 5 are needed for one brake. Therefore, not only a number of parts is large, and part control is troublesome, but also the backing plate 2 and the shoe web 6 need to be formed with the locking hole 3 and the elongated hole 6a, so that cost cannot be restrained to below. Further, in integrating the shoe hold-down mechanism, the shoe hold-down pin 4 is inserted into the elongated hole 6a, and then the coil spring 8 is integrated by compressing it to rotate the shoe hold-down pin 4 by 90° so that the brake shoe is slidably supported on the backing plate 2. Therefore, skill is required and inspection of whether brought into a half-hung state needs to be carried out.

### SUMMARY OF THE INVENTION

One or more embodiments of the invention provide a shoe hold-down mechanism in a drum brake having a small number of parts, facilitated in integrating and capable of being supported on a backing plate in a stable state.

According to one or more embodiments of the invention, in a first aspect, a drum brake is provided with: a backing plate; a brake shoe slidably supported on the backing plate; a return spring, wherein a spring force of the return spring acts to the brake shoe at a position of being offset from a center in a width direction of a rim portion of the brake shoe in a direction of being remote from the backing plate to an upper side; first ledge portions formed at an upper face of the backing plate, wherein faces of the rim portion of the brake shoe brought into contact with the backing plate on a side of a wheel cylinder and on a side of an anchor are brought into contact with and supported by the first ledge portions; and a second ledge portion formed at a lower face of a cut-to-rise portion of the backing plate, wherein a face of the rim portion of the brake shoe brought into contact with the backing plate formed substantially at a center position is brought into contact with and supported by the second ledge portion.

In a second aspect, the drum brake is further provided with: a struck-out nib formed on the face of the rim portion brought into contact with the backing plate, and projected to a side of a web of the brake shoe.

In a third aspect, the drum brake is further provided with: a fold-to-bend piece formed on the face of the rim portion brought into contact with the backing plate, and constituted by being folded to bend to a side of a web of the brake shoe

According to the drum brake of the first aspect, since the brake shoe is brought into contact with and supported on the backing plate at the upper face and the lower face of the backing plate, a number of parts required in the background art for the shoe hold-down mechanism are not required, and it is not necessary to bore holes formed at the backing plate and the shoe web. Further, the brake shoe can be supported on the backing plate in a stable state by utilizing the spring force of the return spring.

According to the drum brake of the second aspect, the face of the rim portion of the brake shoe brought into contact with the backing plate is formed by the struck-out nib, and therefore, the strength of the rim of the brake shoe is intensified, the brake shoe can be finished by only working striking to work the brake shoe which has been used in the background art, and it is not necessary to prepare a brake shoe having a new structure.

According to the drum brake of the third aspect, by providing the fold-to-bend piece to the face of the rim portion of the brake shoe brought into contact with the backing plate, a sliding face can be set to be large and the brake shoe can be supported further stably.

Other aspects and advantages of the invention will be apparent from the following description and the appended claims.

### BRIEF DESCRIPTION OF THE DRAWINGS

FIG. 1 is a front view of a drum brake according to Embodiment 1 of the invention.

FIGS. 2A and 2B illustrate schematic views for explaining a relationship of attaching a return spring and a brake shoe, FIG. 2A shows a relationship of attaching a return spring on a side of a wheel cylinder and a brake shoe, and FIG. 2B shows a relationship of attaching a return spring on a side of an anchor and a brake shoe.

FIGS. 3A to 3C illustrate sectional views of a drum brake according to Embodiment 1 of the invention, FIG. 3A is a sectional view taken along a line A-A of FIG. 1 showing a relationship of bringing substantially a center position of a rim portion and a backing plate into contact with each other, FIG. 3B is a sectional view taken along a line B-B of FIG. 1 showing a relationship of bringing a position of a rim portion at a vicinity of a side of a wheel cylinder and a backing plate into contact with each other, and FIG. 3C is a sectional view taken along a line C-C of FIG. 1 showing a relationship of bringing a position of a rim portion at a vicinity of a side of an anchor and a backing plate into contact with each other.

FIG. 4 is a front view of a drum brake according to Embodiment 2 of the invention.

FIGS. 5A to 5C illustrate sectional views of the drum brake according to Embodiment 2, FIG. 5A is a sectional view taken along a line D-D of FIG. 4 showing a relationship of bringing substantially a center position of a rim portion and a backing plate into contact with each other, FIG. 5B is a sectional view taken along a line E-E of FIG. 4 showing a relationship of bringing a position of a rim portion at a vicinity of a side of a wheel cylinder and a backing plate into contact with each other, and FIG. 5C is a sectional view taken along a line F-F of FIG. 4 showing a relationship of bringing a position of a rim portion at a vicinity of a side of an anchor and a backing plate into contact with each other.

FIG. 6 is a partial sectional view of a shoe hold-down mechanism comprising a coil spring and a shoe hold-down pin of a background art.

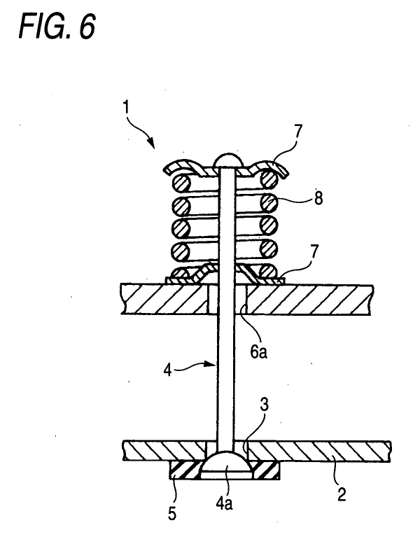

### DESCRIPTION OF REFERENCE NUMERALS AND SIGNS

12 . . . leading trailing type drum brake
14 . . . wheel cylinder
16 . . . anchor
18 . . . backing plate
18a . . . cut-to-rise portion
20 . . . brake shoe
20a . . . web
20b . . . rim portion
20c . . . nib
22 . . . friction lining
24 . . . brake drum
26 . . . return spring
26a . . . end portion
28 . . . return spring
28a . . . end portion
30 . . . brake shoe
30a . . . web
30b . . . rim portion
30c . . . fold-to-bend piece
“a” . . . second ledge portion
“b”, “c” . . . first ledge portions

### DETAILED DESCRIPTION OF THE EXEMPLARY EMBODIMENTS

Exemplary embodiments of the invention will be explained as follows.

### Embodiment 1

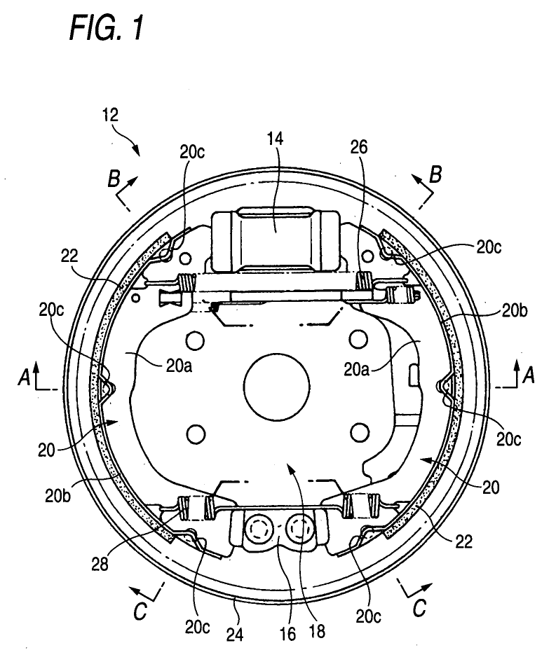

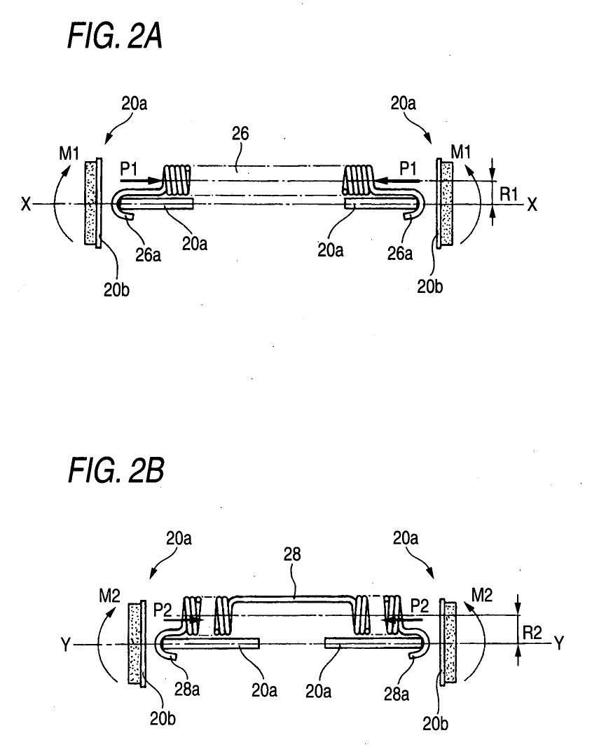

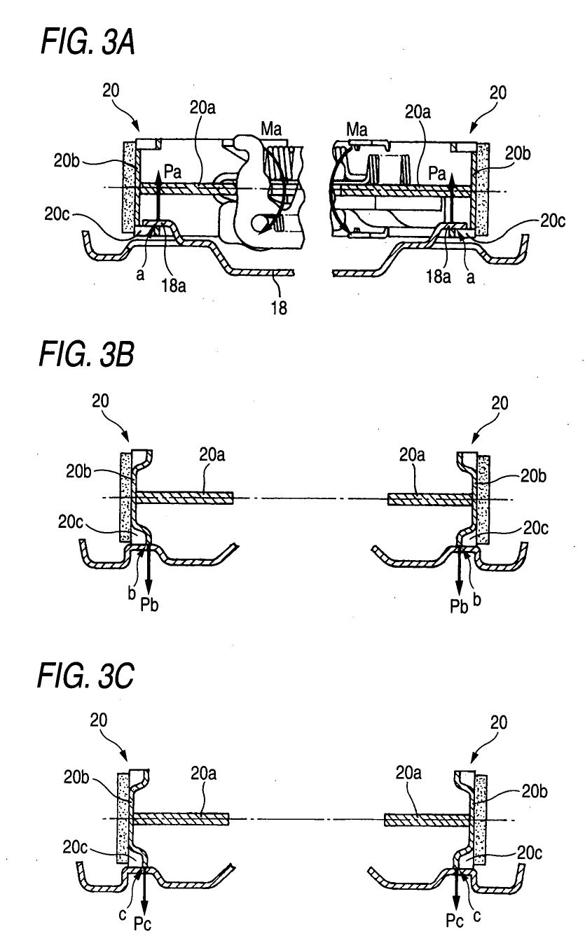

Embodiment 1 of the invention will be explained in reference to FIG. 1 through FIG. 3C. FIG. 1 is a front view of a drum brake to Embodiment 1 of the invention, FIGS. 2A and 2B illustrate schematic views for explaining a relationship of attaching a return spring and a brake shoe, FIG. 2A shows a relationship of attaching a return spring on a side of a wheel cylinder and the brake shoe, and FIG. 2B shows a relationship of attaching a return spring on a side of an anchor and the brake shoe. FIG. 3A is a sectional view taken along a line A-A of FIG. 1 showing a relationship of bringing substantially a center position of a rim portion and a backing plate into contact with each other, FIG. 3B is a sectional view taken along a line B-B of FIG. 1 showing a relationship of bringing a position of the rim portion at a vicinity of a side of the wheel cylinder and the backing plate in contact with each other, FIG. 3C is a sectional view taken along a line C-C of FIG. 1 showing a relationship of bringing a position of the rim portion at a vicinity of a side of the anchor and the backing plate into contact with each other.

As shown in FIG. 1, a shoe hold-down mechanism of the invention is applied to a drum brake 12 of a leading trailing type, and a pair of brake shoes 20, 20 are slidably supported on a backing plate 18 including a wheel cylinder 14 and an anchor 16. One ends of webs 20a, 20a of the brake shoes 20, 20 are brought into contact with a pair of pistons (not illustrated) arranged at inside of the wheel cylinder 14, and other ends thereof are brought into contact with an anchor 16. Rim portions 20b, 20b of the brake shoes 20, 20 are attached with friction linings 22, 22, in operating brake, the brake shoes 20, 20 are expanded by constituting a fulcrum by the anchor 16 by the pair of pistons operated by a hydraulic pressure introduced to the wheel cylinder 14, and a braking operation is carried out by frictionally engaging the friction linings 22, 22 with a brake drum 24.

When the hydraulic pressure introduced to the wheel cylinder 14 is released, the pair of brake shoes 20, 20 are returned to initial positions by spring action of a return spring 26 on a side of the wheel cylinder 14 and a return spring 28 on a side of the anchor 16. There are formed a total of 6 pieces of struck-out nibs 20c projected to the webs 20a, 20a at respective three portions of positions substantially centers of two upper and lower end portions of the rim portions 20b, 20b of the brake shoes 20, 20 and on sides of the wheel cylinder 14 thereof and sides of the anchor 16 thereof. There are a total of 3 pieces of the nibs 20c constituted as faces of being brought into contact with the backing plate 18 on lower end sides of the rim portions 20b, 20b. The struck-out nibs 20c can intensify a rim strength of the brake shoes 20, 20 and constituted by subjecting a brake shoe which has been used in the background art to strike out working and it is not necessary to prepare a brake shoe having a new structure.

As shown in FIG. 2A, the return spring 26 on the side of the wheel cylinder is arranged at a position of being offset from centers in width directions of the rim portions 20b, 20b of the brake shoes 20, 20 in a direction of being remote from the backing plate 18 to an upper side (remote from a center line X-X in the width directions of the rim portions 20b, 20b by R1), and two end portions 26a, 26a of the return spring 26 are respectively locked by the brake shoes 20, 20. In operating brake, when the spring force of the return spring 26 operated in directions of returning the brake shoes 20, 20 to the initial positions is designated by notation P1, the respective brake shoes 20, 20 are operated with a rotational torque of P1×R1=M1.

On the other hand, as shown in FIG. 2B, also the return spring 28 on the side of the anchor 16 is arranged at a position of being offset from the centers in the width directions of the rim portions 20b, 20b of the brake shoes 20, 20 in a direction of being remote from the backing plate 18 to an upper side (remote from a center line Y-Y in the width directions of the rim portions 20b, 20b by R2), and two end portions 28a, 28a of the return spring 28 are respectively locked by the brake shoes 20, 20. In operating brake, when the spring force of the return spring 28 operated in directions of returning the brake shoes 20, 20 to initial positions is designated by notation P2, the respective brake shoes 20, 20 are operated with a rotational moment of P2×R2=M2.

Since the respective brake shoes 20, 20 are operated with the rotational moments of M1, M2 by the spring forces P1, P2 of the return springs 26, 28 in this way, the respective brake shoes 20, 20 on sides of the friction linings 22, 22 receive rotational forces in directions of being remote from the backing plate 18 to the upper side.

However, as shown in FIG. 3A, the lower nibs 20c substantially at center positions of the rim portions 20b, 20b are brought into contact with and supported by lower faces of cut-to-rise portions 18a formed by cutting off the backing plate 18. Further, as shown in FIG. 3B, the lower nibs 20c on the side of the wheel cylinder 14 are brought into contact with and supported by an upper face of the backing plate 18. As shown in FIG. 3C, also the lower nibs 20c on the side of the anchor 16 are brought into contact with and supported by the upper face of the backing plate 18. Therefore, the respective brake shoes 20, 20 are constrained from being rotated by the nibs 20c respectively provided at three positions.

Further, since the cut-to-rise portions 18a are formed on the backing plate 18 by cutting off the backing plate 18, the backing plate 18 is penetrated at the cut-to-rise portions 18a. Therefore, it is preferable to attach covers (not shown) on the respective cut-to-rise portions 18a, so that water or dust is not enter into the drum brake 12 from outside. The covers may be made by material such as rubber.

That is, as shown in FIG. 3A, the rotational moments based on the return springs 26, 28 operated to the respective brake shoes 20, 20 become a rotational moment Ma, and at ledge faces “a” (second ledge portions) constituting lower faces of the cut-to-rise portions 18a of the backing plate 18 and brought into contact with the nibs 20c substantially at center positions of the rim portion 20b, press forces Pa in an upper direction of being remote from the backing plate 18 are generated. Further, as shown in FIG. 3B, by the rotational moment Ma, at ledge faces “b” (first ledge portions) brought into contact with the nibs 20c on the side of the wheel cylinder 14, press forces Pb in a lower direction directed to the backing plate 18 are generated. At ledge faces “c” (first ledge portions) brought into contact with the nibs 20c on the side of the anchor 16, as shown in FIG. 3C, press forces Pc in a lower direction directed to the backing plate 18 are generated.

Further, by the rotational moment Ma, the press forces Pa in the upper direction of being remote from the backing plate 18 generated at the ledge faces “a” are balanced with synthesized forces of the press forces Pb and Pc in the lower direction generated at the ledge faces “b” and ledge faces “c”, the respective brake shoes 20, 20 are constrained by being maintained always in a horizontal state relative to the backing plate 18. Therefore, the respective shoes 20, 20 are prevented from being floated up by an external force, and guided by a small sliding resistance.

In this way, the shoe hold-down mechanism of Embodiment 1 can be provided with a shoe hold-down function equivalent to that of the background art by bringing the three nibs 20c provided at the rim portions 20b, 20b of the brake shoes 20, 20 into contact with the three ledge faces (the first and second ledge portions) “a”, “b”, “c” of the backing plate 18.

### Embodiment 2

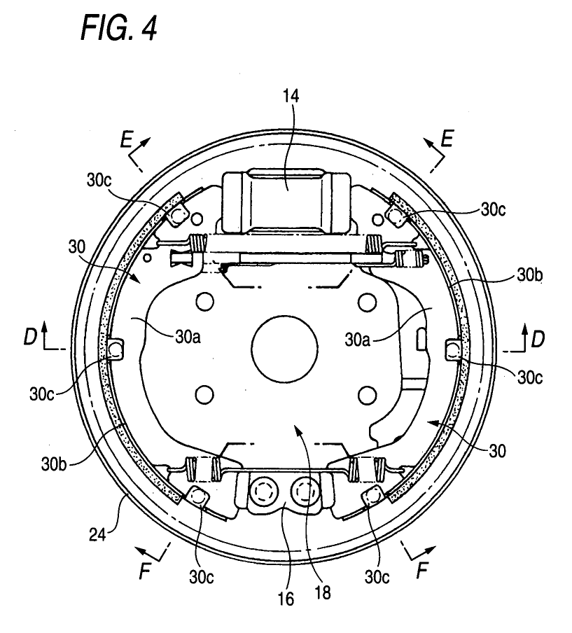

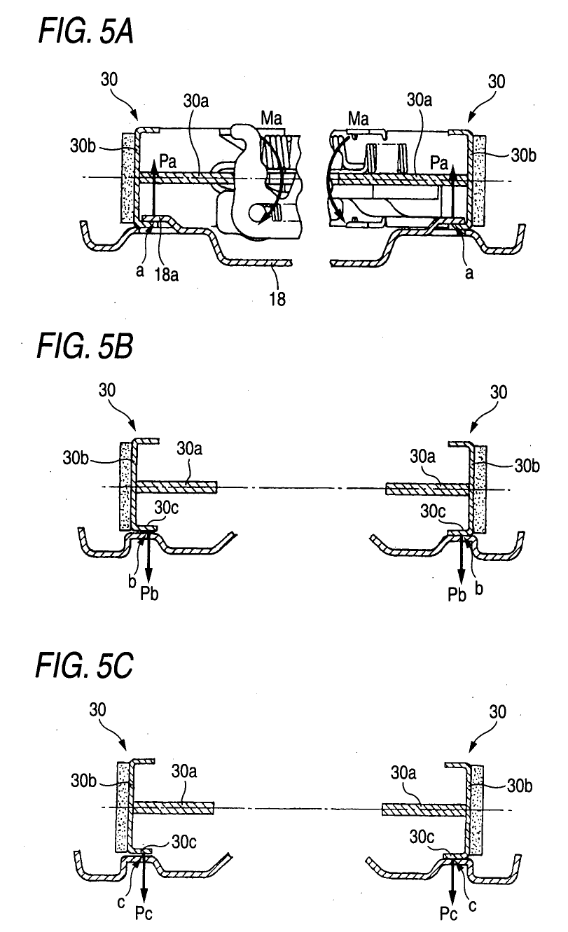

Next, Embodiment 2 of the invention will be explained in reference to FIG. 4 and FIG. 5. FIG. 4 is a front view of a drum brake including a shoe hold-down mechanism according to Embodiment 2. FIG. 5A is a sectional view taken along a line D-D of FIG. 4 showing a relationship of bringing substantially a center position of a rim portion and a backing plate into contact with each other. FIG. 5B is a sectional view taken along a line E-E of FIG. 4 showing a relationship of bringing a position of the rim portion at a vicinity of a side of a wheel cylinder and the backing plate into contact with each other. FIG. 5C is a sectional view taken along a line F-F of FIG. 4 showing a relationship of bringing a position of the rim portion at a vicinity of a side of an anchor and the backing plate into contact with each other. Further, parts common to those of Embodiment 1 are attached with the same notations, and a detailed explanation thereof will be omitted.

There are formed a total of 6 pieces of fold-to-bend pieces 30c folded to bend to webs 30a, 30a at respective three portions at substatially center positions of two upper and lower end portions of rim portions 30b, 30b of brake shoes 30, 30 and on sides of the wheel cylinder 14 and on sides of the anchor 16. There are a total of 3 pieces of the fold-to-bend pieces 30c constituted as faces of being brought into contact with the backing plate 18 on sides of lower ends of the rim portions 30b, 30b.

Further, as shown in FIG. 5A, the lower fold-to-bend pieces 30c substantially at center positions of the rim portions 30b, 30b are brought into contact with and supported by the lower faces of the cut-to-rise portions 18a formed by cutting off the backing plate 18. As shown in FIG. 5B, the lower fold-to-bend pieces 30c on the side of the wheel cylinder 14 are brought into contact with and supported by the upper face of the backing plate 18. As shown in FIG. 5C, also the lower fold-to-bend pieces 30c on the side of the anchor 16 are brought into contact with and supported by the upper face of the backing plate 18. Therefore, the respective brake shoes 30, 30 are constrained from being rotated by the fold-to-bend pieces 30c provided at the respective three locations.

By bringing the fold-to-bend pieces 30c into contact with and supported by the backing plate 18 in this way, as has already been explained in Embodiment 1, the respective brake shoes 30, 30 are constrained by being maintained always in the horizontal state relative to the backing plate 18, prevented from being floated up by the external force, and guided by a small sliding resistance. Further, by providing the fold-to-bend pieces 30c to the faces brought into contact with the backing plate 18, sliding faces can be set by arbitrary sizes and the brake shoes can be supported further stably.

In this way, the shoe hold-down mechanism of Embodiment 2 can be provided with the shoe hold-down function equivalent to that of the background art by bringing the three fold-to-bend pieces 30c provided at the rim portions 30b, 30b of the brake shoes 30, 30 into contact with the three ledge faces (first and second ledge portions) “a”, “b”, “c” of the backing plate 18.

Although Embodiments 1, 2 of the invention have been explained in reference to the drawings, a specific constitution thereof is not limited to the embodiments, but, for example, although the embodiments have been explained by an example of being adapted to a drum brake of a leading and trailing type, the invention can be adopted to a type of a two leading type, a duo servo type or the like.

Further, although a total of 6 pieces of the nibs 20c or the fold-to-bend pieces 30c at two upper and lower end portions of the rim portions, it is sufficient when at least 3 pieces thereof are formed only on sides of lower end portions of the rim portions brought into contact with the backing plate.

What is claimed is:

1. A drum brake comprising:
a backing plate;
a brake shoe slidably supported on the backing plate;
a return spring, wherein a spring force of the return spring acts to the brake shoe at a position of being offset from a center in a width direction of a rim portion of the brake shoe in a direction of being remote from the backing plate to an upper side;
first ledge portions formed at an upper face of the backing plate, wherein faces of the rim portion of the brake shoe brought into contact with the backing plate on a side of a wheel cylinder and on a side of an anchor are brought into contact with and supported by the first ledge portions; and
a second ledge portion formed at a lower face of a cut-to-rise portion of the backing plate, wherein a face of the rim portion of the brake shoe brought into contact with the backing plate formed substantially at a center position is brought into contact with and supported by the second ledge portion.

2. The drum brake according to claim 1, further comprising:
a struck-out nib formed on the face of the rim portion brought into contact with the backing plate, and projected to a side of a web of the brake shoe.

3. The drum brake according to claim 1, further comprising:
a fold-to-bend piece formed on the face of the rim portion brought into contact with the backing plate, and constituted by being folded to bend to a side of a web of the brake shoe.
